(19) United States
(12) Patent Application Publication
(10) Pub. No.: US 2026/0249758 A1
(43) Pub. Date: Aug. 27, 2026

(54) COMPONENT OF SHEET

(71) Applicant: TOYOTA BOSHOKU KABUSHIKI KAISHA, Aichi-ken (JP)

(72) Inventor: Wataru TAGUCHI, Aichi-ken (JP)

(73) Assignee: TOYOTA BOSHOKU KABUSHIKI KAISHA, Aichi-ken (JP)

(21) Appl. No.: 19/544,253

(22) Filed: Feb. 19, 2026

(30) Foreign Application Priority Data
Feb. 26, 2025 (JP) 2025-028723

(51) Int. Cl. B60N 2/56

(52) U.S. Cl. CPC B60N 2/5685

(57) ABSTRACT

A component of a sheet includes a seat pad formed of a foam-molded body, a seat cover covering the seat pad and having a bent portion bent so as to protrude to a seat surface side, a heater base material disposed between the seat cover and the seat pad and having a first through hole penetrating the heater base material in a thickness direction. The seat pad includes a filling portion that is foam molded with a molding material flowing, through the first through hole of the heater base material, into a gap generated between the heater base material and the bent portion of the seat cover and that fills the gap so as to be integrated with the bent portion.

### CROSS-REFERENCE TO RELATED APPLICATIONS

This application is based on and claims priority under 35 USC 119 from Japanese Patent Application No. 2025-028723 filed on February 26, 2025, the entire content of which is incorporated herein by reference.

### TECHNICAL FIELD

The present disclosure relates to a component of a sheet. Specifically, the present disclosure relates to a component of a sheet including a heater that warms a seated person.

### BACKGROUND ART

JP2012-035671A discloses a seat cushion in which a seat pad is foam-molded integrally with a seat cover. The seat cushion includes a planar heater disposed between the seat cover and the seat pad. The heater is adhered to a back surface of the seat cover in advance. A heating wire of the heater is covered from a seat back side by a surface material having low air permeability. Therefore, during foam molding of the seat pad, a molding material is covered by the surface material having low air permeability and is less likely to impregnate the heater. As a result, the seat pad is not molded around the heating wire.

JP2024-162414A discloses a seat cushion having an uneven shape on a seat front surface. The seat cushion includes a seat cover molded in advance in a curved shape so as to form unevenness on a front surface thereof. A seat pad is foam-molded so as to be integrated with the seat cover. Accordingly, the seat pad is molded along the uneven shape.

In JP2012-035671A, the molding material does not flow in a region of the seat cover where the heater is adhered. Therefore, for example, when the heater disclosed in JP2012-035671A is provided on the back side of the seat cover disclosed in JP2024-162414A, the molding material does not flow to the seat cover, and the seat pad is not molded along the uneven shape of the seat cover. As a result, cushioning properties cannot be imparted to the seat front surface. Therefore, there is provided a component of a sheet capable of appropriately integrating a seat cover and a seat pad even in a region of the seat cover where a heater is provided.

To solve the above problem, a component of a sheet according to the present disclosure is configured as follows.

### SUMMARY OF INVENTION

A first aspect of the present disclosure provides a component of a sheet including a seat pad formed of a foam-molded body, a seat cover covering the seat pad and having a bent portion bent so as to protrude to a seat surface side, a heater base material disposed between the seat cover and the seat pad and having a first through hole penetrating the heater base material in a thickness direction. The seat pad includes a filling portion that is foam molded with a molding material flowing, through the first through hole of the heater base material, into a gap generated between the heater base material and the bent portion of the seat cover and that fills the gap so as to be integrated with the bent portion.

According to the above configuration, the filling portion of the seat pad is molded integrally with the bent portion. Accordingly, the seat cover and the seat pad can be appropriately integrated even in a region of the seat cover where the heater base material is provided. Further, cushioning properties can be appropriately imparted to the bent portion.

A second aspect of the present disclosure provides the component of a sheet according to the first aspect, in which the heater base material includes a second through hole at a position facing a seat surface portion separated from the bent portion of the seat cover so that a molding material flows to the seat surface portion. According to the above configuration, the seat pad is integrated with the seat surface portion of the seat cover through the second through hole of the heater base material. Accordingly, the seat cover and the seat pad can be more appropriately integrated.

A third aspect of the present disclosure provides the component of a sheet according to the second aspect, in which the heater base material has a mesh structure, and the first through hole and the second through hole are formed by holes of the mesh structure. According to the above configuration, the first through hole and the second through hole can be easily formed by the mesh structure. Furthermore, the region of the heater base material that is impregnated by the molding material can be reduced by the holes of the mesh structure. Therefore, the heater base material is less likely to become hard, and deterioration of ride comfort of the seat can be restricted.

A fourth aspect of the present disclosure provides the component of a sheet according to the first aspect, further including a plurality of adhesive portions that partially adhere the heater base material to the seat cover in addition to adhesion by the seat pad. According to the above configuration, the adhesive portion can prevent the heater base material from being displaced with respect to the seat cover due to a molding pressure of the seat pad. In addition, since the adhesive portions are dispersed, the heater base material can be appropriately adhered to the seat cover over a wide range, and the flow of the molding material can be less likely to be hindered.

A fifth aspect of the present disclosure provides the component of a sheet according to the first aspect, in which the seat cover is made of a molding material molded into a shape having the bent portion. According to the above configuration, the bent portion and the gap between the bent portion and the heater base material can be appropriately formed.

### BRIEF DESCRIPTION OF DRAWINGS

FIG. 1 is a plan view of a seat cushion according to a first embodiment.

FIG. 2 is a plan view of a seat cushion focusing on a heater and an adhesive portion.

FIG. 3 is a cross-sectional view taken along a line III-III in FIG. 1.

FIG. 4 is a cross-sectional view taken along a line IV-IV in FIG. 2.

### DESCRIPTION OF EMBODIMENTS

### First Embodiment

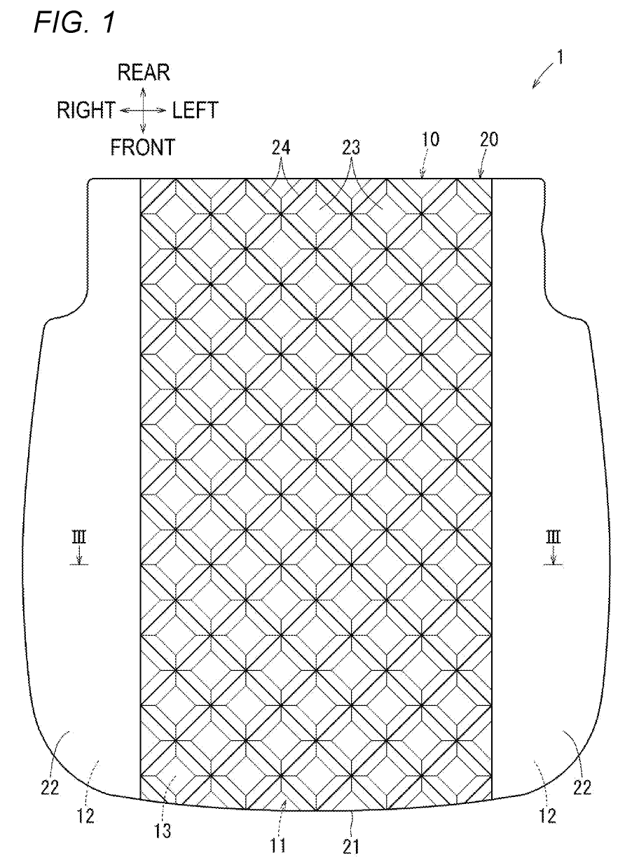

Hereinafter, embodiments of the present disclosure will be described with reference to FIGS. 1 to 4. In the following description, when a direction such as front, rear, upper, lower, left, and right is referred to, the direction indicates a corresponding direction illustrated in the drawings. When a "seat width direction" is described, it is assumed that the "seat width direction" indicates a left-right direction of a seat cushion 1 described later.

### Seat Cushion

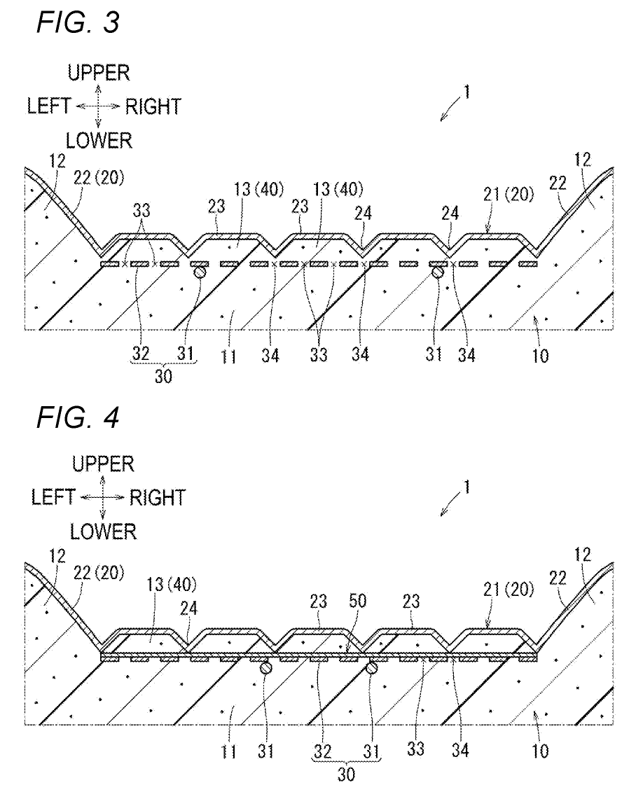

First, the seat cushion 1 according to a first embodiment of the present disclosure will be described. As illustrated in FIGS. 1 and 3, the seat cushion 1 forms a seating portion of a seat for an automobile. The seat cushion 1 includes a cushion pad 10 forming a cushion material and a cushion cover 20 covering the cushion pad 10. The cushion cover 20 includes a plurality of bent portions 23 that are bent so as to protrude upward (toward a seat surface side) from places on a front surface thereof. An uneven shape is formed on a front surface of the cushion cover 20 by the bent portions 23 (see FIG. 3). Here, the seat cushion 1 corresponds to a "component of a sheet" of the present disclosure.

Further, the cushion pad 10 includes filling portions 13 foam-molded along the bent portions 23. The filling portions 13 impart cushioning properties to the bent portions 23. Accordingly, the bent portions 23 receive a load of a seated person and is flexibly deformed. In this way, the filling portion 13 can appropriately improve the sitting comfort of the seat cushion 1.

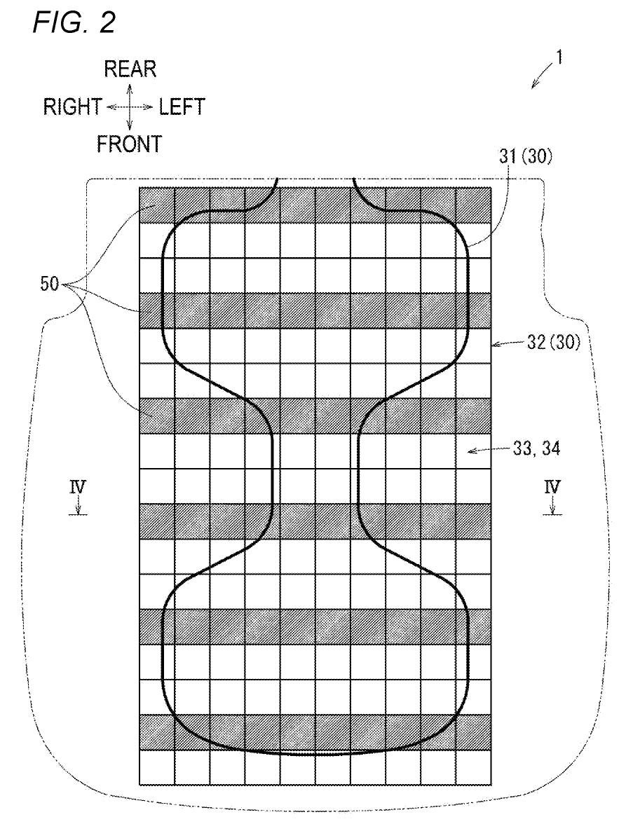

As illustrated in FIGS. 2 and 4, the seat cushion 1 includes a heater 30 provided on a back side of the cushion cover 20. The heater 30 can warm the buttocks of the seated person. The heater 30 includes a planar heater base material 32 assembled to a back surface of the cushion cover 20 via an adhesive portion 50. The heater base material 32 has a mesh shape (mesh structure) over the entire surface thereof.

As illustrated in FIG. 3, the cushion pad 10 is formed integrally with the cushion cover 20 and the heater 30 by foam molding. That is, the cushion cover 20 and the heater 30 are set in a mold (not illustrated) for foam molding the cushion pad 10. A predetermined gap 40 is formed between each bent portion 23 of the cushion cover 20 and the heater base material 32. When a molding material of the cushion pad 10 is fed, the molding material flows into the gap 40 through a first through hole 33 formed by the mesh structure of the heater base material 32.

The filling portion 13 of the cushion pad 10 is formed to fill the gap 40 by foam molding of the cushion pad 10. The filling portion 13 is integrated with each bent portion 23. As described above, since the heater base material 32 has the mesh structure, the molding material can flow to the cushion cover 20 through the heater base material 32. Accordingly, the cushion pad 10 can be appropriately integrated with the cushion cover 20 in the region of the cushion cover 20 where the heater base material 32 is provided. Moreover, since the filling portion 13 is provided along each bent portion 23, the sitting comfort of the seat cushion 1 can be appropriately improved.

### Cushion Pad

Hereinafter, a configuration of each portion of the seat cushion 1 will be described in detail. As illustrated in FIGS. 1 and 3, the cushion pad 10 includes a top plate main portion 11 that supports the buttocks of the seated person from below, and a pair of left and right top plate side portions 12 that support the buttocks of the seated person from both left and right sides. Each top plate side portion 12 has a convex shape protruding upward from the top plate main portion 11. Here, the cushion pad 10 corresponds to a “seat pad” of the present disclosure.

### Cushion Cover

As illustrated in FIG. 1, the cushion cover 20 is a single member formed by vacuum-molding a vinyl chloride resin into a predetermined surface shape. The cushion cover 20 includes a main cover 21 that covers the top plate main portion 11 of the cushion pad 10, and side covers 22 that cover the top plate side portions 12. Each side cover 22 has a convex shape protruding upward from the main cover 21 along the convex shape of the corresponding top plate side portion 12. Here, the cushion cover 20 corresponds to a "seat cover" of the present disclosure.

The main cover 21 of the cushion cover 20 includes the bent portions 23 bent to protrude upward and grooves 24 formed between the bent portions 23. Each bent portion 23 is formed to have a substantially rhombic shape in a plan view. Accordingly, the main cover 21 can be formed into a shape of high design characteristics in which a plurality of rhombic patterns are substantially regularly arranged. Further, the grooves 24 are formed so as to extend in a substantially lattice shape obliquely intersecting the main cover 21. Here, the groove 24 corresponds to a "seat surface portion" of the present disclosure.

The front surface of the cushion cover 20 is subjected to predetermined front surface treatment. Accordingly, the wear resistance of the cushion cover 20 can be improved. The back surface of the cushion cover 20 is subjected to primer treatment. Accordingly, the adhesiveness of the cushion cover 20 to the cushion pad 10 can be appropriately enhanced.

### Heater

As illustrated in FIG. 2, the heater 30 includes the heater base material 32 and a heating wire 31 fixed to the heater base material 32. The heater base material 32 is a cloth member woven in a mesh shape such as cheesecloth. The heater base material 32 has a plurality of through holes 33 and 34 formed by the mesh structure. The heating wire 31 is integrally joined to a back surface of the heater base material 32 in a meandering manner along the heater base material 32. The heating wire 31 is joined to the heater base material 32 by, for example, welding a resin (not illustrated) provided around the heating wire 31 to the heater base material 32. The heating wire 31 may be fixed to the heater base material 32 by sewing, for example. The heating wire 31 may be joined to a front surface of the heater base material 32.

### Adhesive Portion

As illustrated in FIGS. 2 and 4, the seat cushion 1 includes a plurality of adhesive portions 50 that adhere the front surface of the heater base material 32 to the cushion cover 20 from below. Each adhesive portion 50 is a band-shaped double-sided tape and is attached to the front surface of the heater base material 32 so as to extend long in the left-right direction. The adhesive portions 50 are provided at predetermined intervals in a front-rear direction. By dispersing the adhesive portions 50 in this way, it is possible to restrict the flow of the molding material from being hindered during foam molding of the cushion pad 10. The adhesive portions may be attached so as to extend long in the front-rear direction and provided at intervals in the left-right direction.

### Adhesion of Heater Base Material

As illustrated in FIGS. 3 and 4, the heater base material 32 is adhered to the cushion cover 20, which is molded in advance, from below via the adhesive portions 50. Accordingly, the heater base material 32 is adhered to the grooves 24 of the cushion cover 20. The gap 40 is formed between the heater base material 32 and each bent portion 23 by adhering the heater base material 32. Further, the through holes 33 and 34 of the heater base material 32 are divided into a first through hole 33 disposed at a position facing the corresponding bent portion 23 and a second through hole 34 disposed at a position facing the corresponding groove 24.

### Foam Molding of Cushion Pad

The cushion cover 20 and the heater 30 adhered to each other are set in a mold (not illustrated). Specifically, the cushion cover 20 is set to overlap a molding surface for forming a surface shape of a pad surface of the mold. The molding material is fed into a cavity of the mold, and the cushion pad 10 is foam-molded. Since the cushion cover 20 and the heater 30 are adhered to each other by the adhesive portion 50 in advance, it is possible to prevent the heater 30 from being displaced due to a molding pressure of the cushion pad 10.

As illustrated in FIG. 3, the molding material flows into the gaps 40 through the first through holes 33 of the heater base material 32. Accordingly, the filling portion 13 of the cushion pad 10 is foam-molded so as to be integrated with the bent portions 23. The molding material also flows into the grooves 24 through the second through holes 34 of the heater base material 32. Therefore, the cushion pad 10 is foam-molded so as to be integrated with the grooves 24. In this way, the cushion pad 10 is integrated with the main cover 21 through the through holes 33 and 34 of the heater base material 32. That is, the cushion pad 10 can be appropriately integrated with the cushion cover 20 including the region where the heater 30 is provided. Thus, the integrity of the cushion cover 20 with the cushion pad 10 can be further enhanced.

Since the gap 40 between each bent portion 23 and the heater base material 32 is filled with the filling portion 13, cushioning properties can be appropriately imparted to each bent portion 23. Accordingly, the sitting comfort of the seat cushion 1 can be improved, and the design shape of each bent portion 23 can be stabilized so as not to be flattened.

Since the heater base material 32 has a mesh structure, area of the heater base material 32 impregnated by the molding material can be further reduced. Therefore, the heater base material 32 is less likely to be hard by foam molding of the cushion pad 10. Accordingly, it is possible to reduce foreign-object sensation of the seat cushion 1 and further improve the sitting comfort.

To summarize the above, the component of a sheet according to the first embodiment may have the following configuration. In the following description, reference signs assigned in parentheses correspond to the configurations described in the embodiment described above.

That is, a component (1) of a sheet includes a seat pad (10) formed of a foam-molded body, a seat cover (20) covering the seat pad (10) and having a bent portion (23) bent so as to protrude to a seat surface side, and a heater base material (32) disposed between the seat cover (20) and the seat pad (10) and having a first through hole (33) penetrating the heater base material (32) in a thickness direction. The seat pad (10) includes a filling portion (13) that is foam molded with a molding material flowing, through the first through hole (33) of the heater base material (32), into a gap (40) generated between the heater base material (32) and the bent portion (23) of the seat cover (20) and that fills the gap (40) so as to be integrated with the bent portion (23).

According to the above configuration, the filling portion (13) of the seat pad (10) is molded integrally with the bent portion (23). Accordingly, the seat cover (20) and the seat pad (10) can be appropriately integrated even in a region of the seat cover (20) where the heater base material (32) is provided. Further, cushioning properties can be appropriately imparted to the bent portion (23).

Further, in the component (1) of a sheet, the heater base material (32) includes a second through hole (34) at a position facing a seat surface portion (24) separated from the bent portion (23) of the seat cover (20) so that the molding material flows to the seat surface portion (24). According to the above configuration, the seat pad (10) is integrated with the seat surface portion (24) of the seat cover (20) through the second through hole (34) of the heater base material (32). Accordingly, the seat cover (20) and the seat pad (10) can be more appropriately integrated.

Further, in the component (1) of a sheet, the heater base material (32) has a mesh structure, and the first through hole (33) and the second through hole (34) are formed by holes of the mesh structure. According to the above configuration, the first through hole (33) and the second through hole (34) can be easily formed by the mesh structure. Furthermore, the region of the heater base material (32) that is impregnated by the molding material can be reduced by the holes of the mesh structure. Therefore, the heater base material (32) is less likely to become hard, and deterioration of ride comfort of the seat can be restricted.

Further, in the component (1) of a sheet, in addition to adhesion by the seat pad (10), a plurality of adhesive portions (50) that partially adhere the heater base material (32) to the seat cover (20) are provided. According to the above configuration, the adhesive portion (50) can prevent the heater base material (32) from being displaced with respect to the seat cover (20) due to a molding pressure of the seat pad (10). In addition, since the adhesive portions (50) are dispersed, the heater base material (32) can be appropriately adhered to the seat cover (20) over a wide range, and the flow of the molding material can be less likely to be hindered.

Further, in the component (1) of a sheet, the seat cover (20) is made of a molding material molded into a shape having the bent portion (23). According to the above configuration, the bent portion (23) and the gap (40) between the bent portion (23) and the heater base material (32) can be appropriately formed.

### Other Embodiments

The present disclosure has been described with reference to one embodiment, whereas the present disclosure can be implemented in various forms other than the above embodiment.

1. The component of a sheet can also be applied to a seat back in addition to the seat cushion. The component of a sheet can be widely applied to seats provided for various vehicles other than an automobile, such as a railroad vehicle, an aircraft, and a ship, gaming chairs, and the like, in addition to the seat of the automobile.

2. The heater base material may be a mesh shape member made of resin or metal other than a cloth member. The heater base material does not need to have a mesh structure over the entire surface, and may have a mesh structure only partially. Further, the heater base material is sufficient to have the first through hole at a position facing the bent portion of the seat cover without having the mesh structure. The heater base material may not be adhered to the seat cover during foam molding of the seat pad.

3. The seat cover may be molded using a mold different from the mold for the seat pad, or may be molded using the same mold as the mold for the seat pad. That is, in the latter case, after the seat cover is first molded, the heater is directly adhered to the seat cover without removing the seat cover and then the seat pad is foam-molded.

4. The adhesive portion may be an adhesive material other than the double-sided tape. For example, the adhesive material may be sprayed onto the back surface of the seat cover, and in this case, the adhesive material may not be dispersed and may be widely and uniformly sprayed onto the seat cover. The adhesive portions may be provided, for example, in a lattice shape or in a regular dot pattern as long as the adhesive portions are dispersed from each other, or may be provided in any other arrangement.

What is claimed is:

1. A component of a sheet, comprising:
a seat pad formed of a foam-molded body;
a seat cover covering the seat pad and having a bent portion bent so as to protrude to a seat surface side; and
a heater base material disposed between the seat cover and the seat pad and having a first through hole penetrating the heater base material in a thickness direction,
wherein the seat pad includes a filling portion that is foam molded with a molding material flowing, through the first through hole of the heater base material, into a gap generated between the heater base material and the bent portion of the seat cover and that fills the gap so as to be integrated with the bent portion.

2. The component of a sheet according to claim 1,
wherein the heater base material includes a second through hole at a position facing a seat surface portion separated from the bent portion of the seat cover so that a molding material flows to the seat surface portion.

3. The component of a sheet according to claim 2,
wherein the heater base material has a mesh structure, and the first through hole and the second through hole are formed by holes of the mesh structure.

4. The component of a sheet according to claim 1, further comprising:
a plurality of adhesive portions that partially adhere the heater base material to the seat cover in addition to adhesion by the seat pad.

5. The component of a sheet according to claim 1,
wherein the seat cover is made of a molding material molded into a shape having the bent portion.
